(19) United States
(12) Patent Application Publication
(10) Pub. No.: US 2005/0219382 A1
(43) Pub. Date: Oct. 6, 2005

(54) Digital camera device and method for generating image pick-up signal

(76) Inventors: Tatsuro Abe, Tokyo (JP); Takato Katagiri, Tokyo (JP); Shiro Nagaoka, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/086,568

(22) Filed: Mar. 23, 2005

(30) Foreign Application Priority Data
Mar. 23, 2004 (JP) 2004-85603

(51) Int. Cl. H04N 5/76

(52) U.S. Cl. 348/231.99

(57) ABSTRACT

A digital camera device includes a digital compressed image data generating unit which generates digital compressed image data having a large number of a group of pictures (GPOs) having a plurality of picture frames based on a video signal generated by picking-up an image of a subject by an image pick-up, and which adds, to a header (SH) of the picture group, address information on a predetermined picture frame (P picture) in the picture groups of the digital compressed image data. The digital compressed image data is recorded to the recording medium. Thus, the picked-up and generated image data is fast transferred to an image recording and reproducing device without deterioration.

### CROSS-REFERENCE TO RELATED APPLICATIONS

This application is based upon and claims the benefit of priority from the prior Japanese Patent Application No. 2004-85603 filed on Mar. 23, 2004; the entire contents of which are incorporated herein by reference.

### BACKGROUND OF THE INVENTION

1. Field of the Invention

The present invention relates to a digital camera device and a method for generating an image pick-up signal which can fast transfer, to various external recording devices, digital image data that is picked-up and is recorded to a digital camera.

2. Description of the Related Art

Conventionally, a digital video camera for sequentially recording digital image data to a magnetic tape is put into practical use, as an image recording and reproducing device in which a moving image or a still image signal that is generated by picking-up an image of a subject by an image pick-up device is subjected to digital processing, the digital image data is recorded to a recording medium, and the recorded digital image data is reproduced.

Recently, the widespread of a personal computer and the Internet enables the practical use of digital cameras, including a digital video camera and a digital still camera using a random access recording medium such as a hard disk, an optical disk, and a semiconductor memory.

Particularly, in the recent digital still camera, a continuous photographing function enables the image pick-up operation and the recording operation of both the moving image and the still image for a predetermined time. According to a method for recording the moving image and the still image to the recording medium, the still image is recorded to a magnetic tape for moving image, the still image is recorded to the semiconductor memory serving as the recording medium different from that of the moving image, or the still image is recorded to the optical disk or hard disk.

Upon recording the digital image data to the various recording media, an image pick-up signal is converted into a digital signal, then, the digital signal is compressed, the digital image data is generated, and a large number of moving images or still image data can be recorded to the recording medium.

The compressing method of the digital signal includes JPEG, MPEG1, MPEG2, and the like. The moving image or still image is compressed by the above-mentioned compressing method, and the compressed image is recorded to the magnetic tape serving as the sequential access medium or the hard disk, optical disk, or semiconductor memory serving as the random access medium.

A TV receiver serving as an image reproducing and display device for reproducing and displaying the moving image or still image recorded by the compressing method has a screen aspect (4:3) of a standard television and a screen aspect (16:9) of a high-definition television (HDTV). The digital TV standard includes 480 interlace (hereinafter, referred to as an I), 480 progressive (hereinafter, referred to as a P), 720P, 1080I, and the like, which are classified by the vertical resolution.

In addition to the TV receivers, the moving image or still image is reproduced and is displayed on a monitor for personal computer with high resolution, and the still image is printed by a printer.

That is, the conventional digital cameras need the compressing and recording method of the moving image and still image onto the recording medium and the recording format corresponding to the TV receiver, monitor, and printer which output, reproduce, and display the digital image data that is picked-up and is recorded.

Japanese Unexamined Patent Application Publication No. 2004-32105 proposes a digital camera wherein upon picking-up and recording the image of the subject, the image data is generated and is recorded to the recording medium in accordance with the recording format corresponding to a plurality of reproducing and display formats, namely, corresponding to the standard TV and high-definition TV (HDTV) and, upon reproducing the image data, the digital camera restores the image data recorded to the recording medium to the image data in accordance with the reproducing and display format and outputs it.

In the conventional digital cameras, the image data is restored to the data in the recording format corresponding to the reproducing and display device and is outputted to generate the image data in the recording format corresponding to the reproducing and display device on the reproducing and display side, record the generated image data to the recording medium, and reproduce the image data from the recording medium. However, if the digital camera side uses a reproducing and displaying device having the recording format different from that of the digital camera side, namely, the recording format for recording no image data or recording format for recovering no image data, the reproducing and display device side needs to convert the recording format for reproducing and displaying the image data outputted from the conventional digital camera into a recording format in which the image data can be reproduced and displayed in the reproducing and display device.

That is, in the case of reproducing and displaying the image data picked-up and recorded by the conventional digital camera by the reproducing and display device, the image data is converted into the data in the recording format corresponding to the reproducing and display device on the digital camera side or the image data from the digital camera is converted into the data in the recording format corresponding to the reproducing and display device on the side thereof so as to reproduce and display the image data.

However, in the case of transferring the image data picked-up and recorded by the conventional digital cameras to the image recording and reproducing device having the hard disk, optical disk, or semiconductor memory serving as the random access medium, so-called dubbing, the image data in a video format transferred from the digital camera needs to be decoded in the image recording and reproducing device and the decoded image data needs to be encoded to the data in the recording format in the image recording and reproducing device, that is, re-conversion, and further needs to be recorded if the recording format of the digital camera is different from that of the image recording and reproducing device. The re-conversion and recording require the same time as those of the actual image pick-up time of the image data, and the image quality deteriorates due to the re-conversion of the recording format of the image data.

In the case of transferring the image data of the digital cameras to the personal computer and recording, managing, reproducing, and displaying the image data on the personal computer, the personal computer decodes, once, the video format of the image data transferred from the digital camera, and further re-converts the decoded video format into the video format of the personal computer. The re-conversion requires the same time as that of the actual image pick-up time for picking-up the image by the digital cameras, and the re-conversion results in the deterioration in image quality.

### BRIEF SUMMARY OF THE INVENTION

Accordingly, it is an object of the present invention to provide a digital camera device and a method for generating an image pick-up signal, the device and method can generate an image data of a subject in a recording format with which the picked-up and generated image data is transferred to an image recording and reproducing device fast without deterioration.

A digital camera device according to the present invention comprises: an image pick-up unit which picks up an image of a subject and generating a video signal; a digital compressed image data generating unit which generates digital compressed image data having a large number of picture groups comprising a plurality of picture frames based on the video signal from the image pick-up unit, and which adds, to a header portion of the picture group, address information on a predetermined picture frame in the picture groups of the digital compressed image data; and a recording unit which records, to a recording medium, the digital compressed image data that is generated by the digital compressed image data generating unit.

In the digital camera device according to an aspect of the present invention, the digital compressed image data recorded to the recording medium is fast transferred to image recording and reproducing devices via data transfer lines, in the same state of the digital compressed image data.

In the digital camera device according to another aspect of the present invention, in the digital compressed image data, the header portions of the picture groups have address information of a first P picture and a second P picture in each of the picture groups comprising a plurality of picture frames starting an I picture.

A method for generating an image pick-up signal according to another aspect of the present invention comprising: a step to generate digital compressed image data having a large number of picture groups comprising a plurality of picture frames based on a video signal generated by picking-up an image of a subject; and a step to generate the digital compressed image data comprising a header portion of each of the picture groups comprising address information on a predetermined picture frame in the picture groups of the digital compressed image data and record the generated data to a recording medium.

In the method for generating the image pick-up signal according to another aspect of the present invention, the digital compressed image data recorded to the recording medium is fast transferred to image recording and reproducing devices via data transfer lines, in the same state of the digital compressed image data.

In the method for generating the image pick-up signal according to another aspect of the present invention, the digital compressed image data comprises a header portion of the picture group comprising address information of a first P picture and a second P picture in each of the picture groups comprising a plurality of picture frames starting an I picture.

In the digital camera device according to the present invention, the image recording and reproducing device does not require the re-conversion of the video format and the compressed image data is fast transferred without deterioration.

### BRIEF DESCRIPTION OF THE DRAWINGS

FIG. 1 is a block diagram showing the structure of a digital camera device according to an embodiment of the present invention;

FIG. 2 is an explanatory diagram for explaining a state in which a DVD recorder and a TV monitor are connected to the digital camera device by a LAN line according to the embodiment of the present invention;

FIG. 3 is an explanatory diagram for explaining a recording format of compressed image data of the digital camera device according to the embodiment of the present invention;

FIG. 4 is a flowchart for explaining the transfer operation of the compressed image data between the digital camera device and the DVD recorder according to the embodiment of the present invention; and

FIG. 5 is an explanatory diagram for explaining a state in which the DVD recorder and the TV monitor are connected to the digital camera device via a cradle by the LAN line according to the embodiment of the present invention.

### DETAILED DESCRIPTION OF THE INVENTION

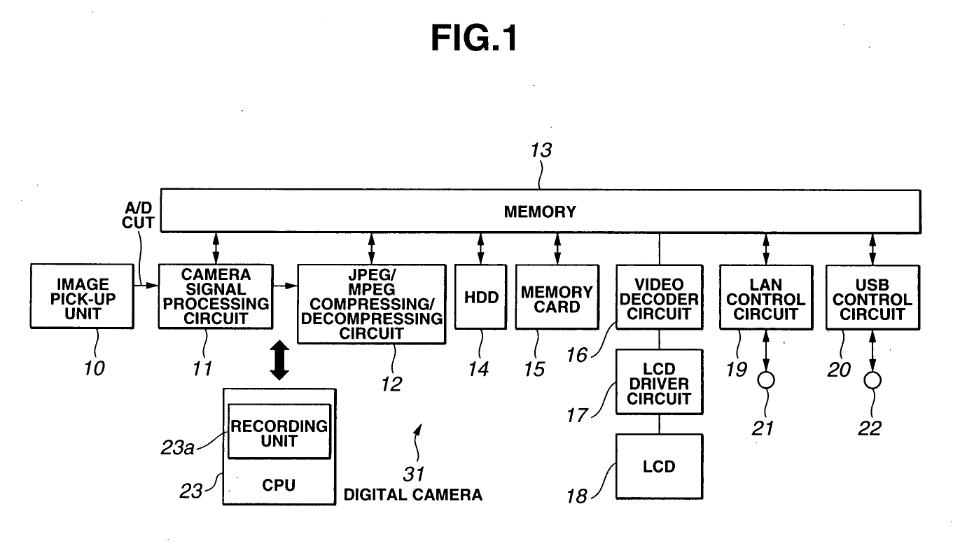

Hereinbelow, an embodiment of the present invention will be described in detail with reference to the drawings. First, a description is given of the structure of a digital camera device with reference to FIG. 1 according to the embodiment of the present invention.

According to the embodiment of the invention, a digital camera 31 comprising: an image pick-up unit 10 comprising a solid-state image pick-up device, which A/D converts an analog image pick-up signal that is generated by photoelectrically converting a subject image by the solid-state image pick-up device, into a digital image pick-up signal, and outputs the digital image pick-up signal; a camera signal processing circuit 11 which inputs an A/D converting signal and performs predetermined signal processing such as white balance; a JPEG/MPEG compressing/decompressing circuit 12, serving as the digital compressed image data generating unit, which compresses/decompresses the digital image signal subjected to the signal processing by the camera signal processing circuit 11 in a JPEG format (in the case of the still image) or in an MPEG format (in the case of the moving image); a memory 13 which temporarily records the compressed image data from the JPEG/MPEG compressing/decompressing circuit 12; a hard disk drive (hereinafter, referred to as an HDD) 14 which records, to a hard disk, the compressed image data temporarily-recorded to the memory 13; a memory card 15 serving as a non-volatile memory; a video decoder circuit 16 which decodes the compressed image data temporarily-recorded to the memory 13; an LCD driver circuit 17 which controls the driving operation of a liquid crystal display panel (hereinafter, referred to as an LCD) 18 based on the image signal decoded by the video decoder circuit 16; a LAN control circuit 19 and a LAN output terminal 21 which transfer the compressed image data recorded to the HDD 14 or memory card 15 to an image recording and reproducing device via LAN line; a USB control circuit 20 and a USB output terminal 22 which transfer the compressed image data recorded to the HDD 14 or memory card 15 to the image recording and reproducing device via a USB line; and a CPU 23, serving as a microprocessor, which controls the entire driving operation of the digital camera 31. The digital camera 31 reproduces, to the memory 13, a control program based on a software stored in the hard disk upon turning on the power, and the CPU 23 controls and calculates the data by using the control program.

The JPEG/MPEG compressing/decompressing circuit 12 serving as an unit for generating the digital compressed image data has a function for generating the digital compressed image data (JPEG or MPEG image data) having a large number of a group of pictures GOP comprising a plurality of picture frames based on a video signal from the image pick-up unit 10, and a function for adding, to a header portions of the picture groups, address information on a predetermined picture frame in the picture group GOP of the digital compressed image data, which will be described later.

The hard disk of the HDD 14 and the memory card 15 serving as the non-volatile memory function as the recording media which record the digital compressed image data that is generated by the digital compressed image data generating unit.

The CPU 23 controls the entire driving operation of the digital camera 31 under the control program, and further controls the writing and reproducing operation of the digital compressed image data to the recording medium. That is, the CPU 23 comprises recording unit 23a which records, to the recording medium, the digital compressed image data generated by the JPEG/MPEG compressing/decompressing circuit 12 and reproduces the recorded data from the recording medium.

The video decoder circuit 16 reproduces the compressed image data recorded to the HDD 14 or memory card 15, and reproduces and displays the image data decompressed by the JPEG/MPEG compressing/decompressing circuit 12 on the LCD 18.

Although not shown, the digital camera 31 comprises an optical lens system which captures subject light to the solid-state image pick-up device and a function for focusing and adjusting the stop of the optical lens system by using the light measurement of the subject and the distance measurement to the subject and driving the shutter, or the like. However, the functions are not described because they do not directly relate to the present invention.

That is, under the control operation of the CPU 23, the still image signal, serving as an analog signal, photo-electrically-converted by the solid-state image pick-up device is converted into the digital signal, and is inputted to the camera signal processing circuit 11, upon picking-up the still image by the digital camera 31. In the camera signal processing circuit 11, the digital still image signal is subjected to a predetermined signal processing and is outputted to the JPEG/MPEG compressing/decompressing circuit 12. In the JPEG/MPEG compressing/decompressing circuit 12, the still image data subjected to the JPEG compression is temporarily recorded to the memory 13, and the still image data temporarily-recorded is decoded by the video decoder circuit 16, and the still image picked-up is reproduced and is displayed on the LCD 18 via the LCD driver circuit 17. Further, the still image is recorded to the HDD 14 or the memory card 15.

Under the control of the CPU 23, in the case of picking-up the moving image by using the digital camera 31, the moving image signal, serving as the analog signal, photoelectrically-converted by the solid-state image pick-up device is converted into the digital signal, and is inputted to the camera signal processing circuit 11. In the camera signal processing circuit 11, the digital moving image signal is subjected to predetermined signal processing, and is outputted to the JPEG/MPEG compressing/decompressing circuit 12. In the JPEG/MPEG compressing/decompressing circuit 12, the moving image data that is subjected to an MPEG compression is temporarily recorded to the memory 13, and the temporarily-recorded moving image data is decoded by the video decoder circuit 16, and the moving image picked-up is reproduced and is displayed on the LCD 18 via the LCD driver circuit 17, and the image is recorded to the HDD 14 or memory card 15.

In the case of reproducing the compressed still image data or compressed moving image data that is recorded to the HDD 14 or the memory card 15, the compressed still image data or compressed moving image data reproduce from the HDD 14 or memory card 15 is decompressed by the JPEG/MPEG compressing/decompressing circuit 12. Further, the decompressed data is outputted to the video decoder circuit 16 via the memory 13, and is subjected to a predetermined decoding. The still image or moving image is reproduced and is displayed on the LCD 18 via the LCD driver circuit 17 and is a picked-up image is checked.

In the case of transferring the compressed still image data or compressed moving image data recorded to the HDD 14 or memory card 15 in the digital camera 31 to the personal computer or a DVD recorder serving as an external image recording and reproducing device, conventionally, the video decoder circuit 16 decodes the moving image data that is recorded to the HDD 14 or the memory card 15 and is MPEG-compressed, and the decoded data is demodulated to the analog image signal. The demodulated analog image signal is outputted to the DVD recorder from a video terminal or an S terminal arranged to the digital camera. In the DVD recorder, the MPEG compressing circuit thereof MPEG-compresses the analog image signal transferred from the digital camera 31 again, and the compressed data is recorded to the hard disk or optical disk serving as the recording medium of the DVD recorder.

In the digital camera 31, the compressed moving image data of the moving image data picked-up and recorded for one hour is transferred and is recorded to the DVD recorder for the same one hour as the image picked-up time. Further, the case of transferring the moving image data by using a USB line or LAN line to the personal computer from the digital camera 31 is the same as that of the DVD recorder.

Then, in the digital camera 31 according to the embodiment of the present invention, a header portion has positional information of one picture frame of a group of pictures (GOP) in the MPEG compressing format. Thus, it has been noted that in the DVD recorder the data in the MPEG compressing format is recognized as streaming data and is fast transferred to the DVD recorder or personal computer via the LAN line.

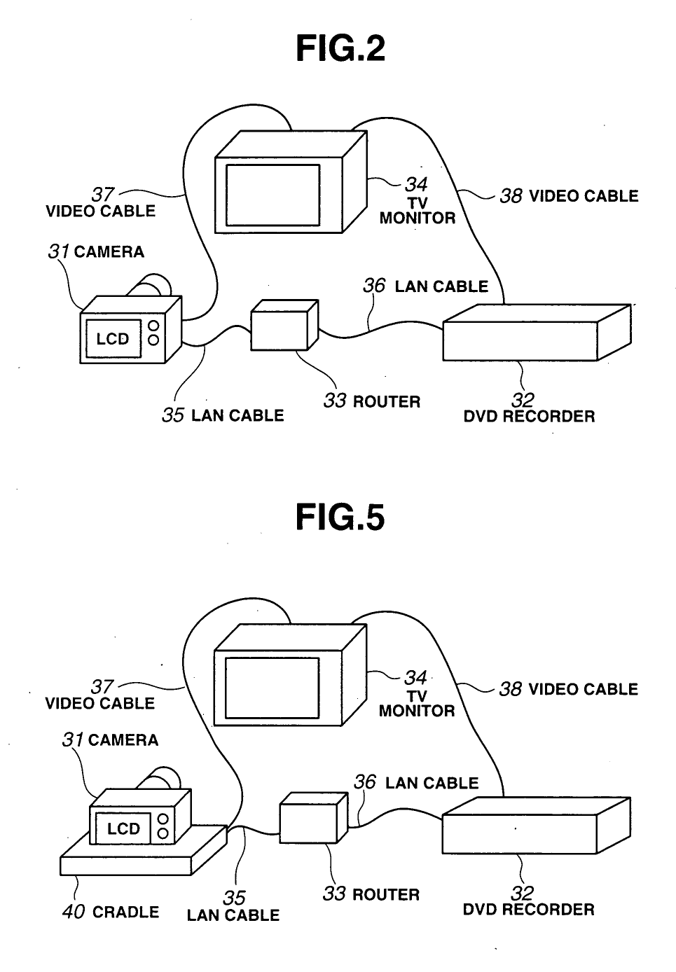

FIG. 2 is an explanatory diagram for explaining a state of connecting the DVD recorder and the TV monitor to the digital camera device via a LAN line according to the embodiment of the present invention.

Referring to FIG. 21, the LAN output terminal 21 of the digital camera 31 according to the embodiment of the present invention is connected to a router 33 via a LAN cable 35, and the router 33 is connected to a DVD recorder 32 via a LAN cable 36. Incidentally, the DVD recorder 32 may directly be connected to the digital camera 31 without getting through the router 33.

The digital camera 31 is connected to a TV monitor 34 via a video cable 37. Further, the DVD recorder 32 is connected to the TV monitor 34 via a video cable 38.

The TV monitor 34 displays the moving image comprising the compressed image signal outputted from the digital camera 31 and an operation menu of the digital camera 31. The input of the TV monitor 34 is switched, thereby displaying the moving image recorded to the DVD recorder 32 or an operation menu of the DVD recorder 32.

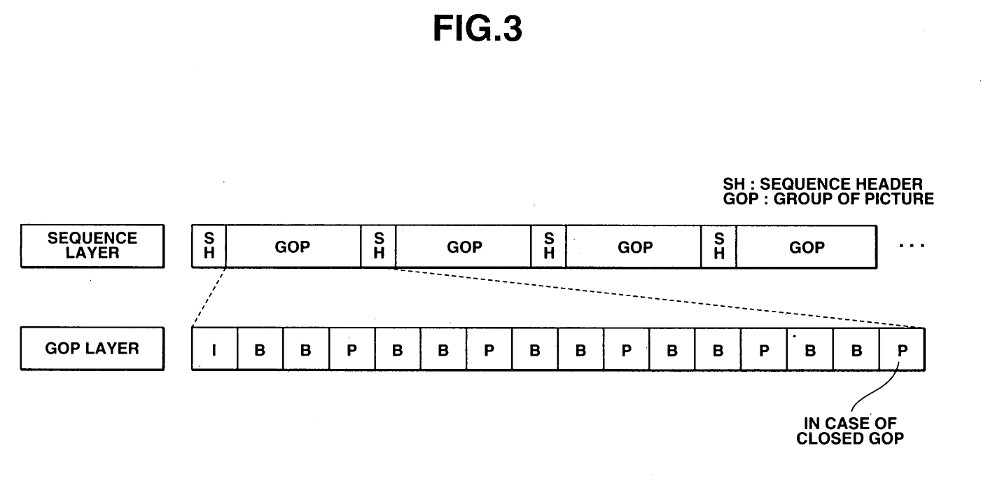

In the digital camera 31 according to the present invention, referring to FIG. 3, the moving image signal is encoded to streaming data comprising sequence layers comprising a sequence header (SH) and picture group data (also referred to a group of pictures, abbreviated to a GOP hereinafter) in accordance with the MPEG2 compression to MPEG compress the moving image signal in the JPEG/MPEG compressing/decompressing circuit 12 shown in FIG. 1. The GOP of the sequence layers comprises 15 frames of Intra-Picture (hereinafter, abbreviated to an I picture), Predictive-Picture (hereinafter, abbreviated to a P picture) in the inter-frame direction, and Bidirectionally predictive-Picture (hereinafter, abbreviated to a B picture)

Further, in the digital camera 31 according to the present invention, the JPEG/MPEG compressing/decompressing circuit 12 writes and records address information of the first P picture and the second P picture to the sequence header SH from among the plurality of picture frames of the P pictures and B pictures starting from the I picture formed by the GOP, and thus the DVD recorder 32 recognizes that the moving image data transferred from the digital camera 31 is compressed by the MPEG2 method. The compressed moving image data transferred from the digital camera 31 is fast recorded as it is to the recording medium of the DVD recorder 32. The DVD recorder 32 does not need to decode the compressed moving image data from the digital camera 31 once and encode it to the compressed image data again, and thus the compressed moving image data can be fast transferred without deterioration.

The transfer time is reduced to 1/10, as compared with the time for decoding once the compressed moving image data transferred from the conventional digital camera to the DVD recorder 32, encoding again the decoded moving image data to the compressed moving image data of the DVD recorder 32, and recording the encoded data. Therefore, the moving image data corresponding to one hour is fast transferred and recorded in about six min, and the data deterioration is prevented without the re-encoding processing of the compressed moving image data.

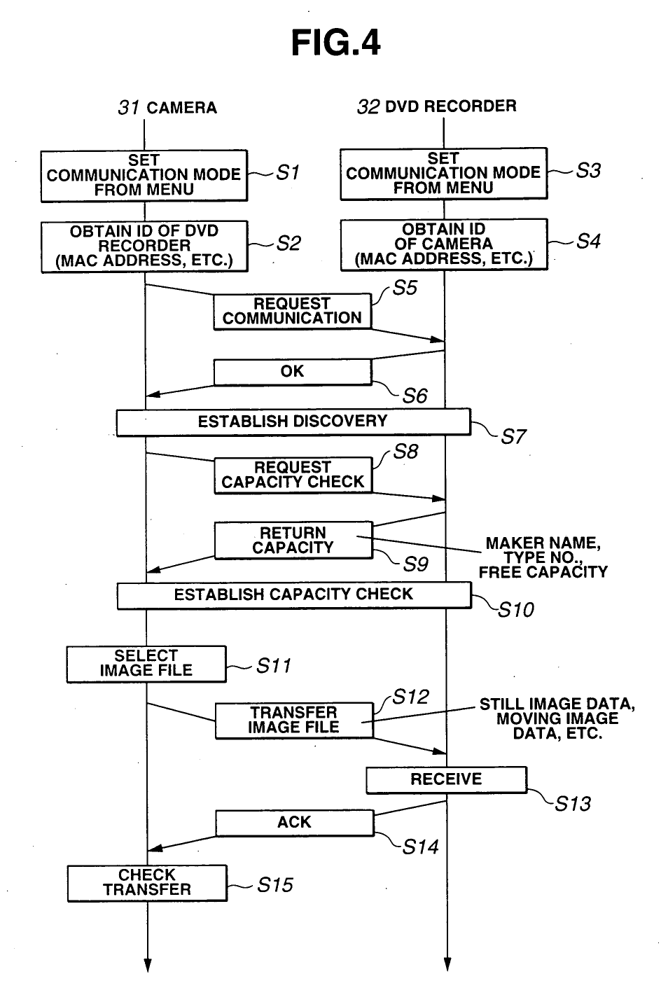

A description is given of the operation for transferring and recording the moving image data to the DVD recorder 32 from the digital camera 31 with reference to FIG. 4.

FIG. 4 is a flowchart for explaining the operation for transferring the compressed image data between the digital camera device and the DVD recorder according to the embodiment of the present invention.

Referring to FIG. 2, the digital camera 31 and the DVD recorder 32 are connected to the router 33 by the LAN cables 35 and 36 and then the digital camera 31 reproduces the setting of a communication mode from a menu screen and displays the reproducing data on the TV monitor 37 (in step S1). On the setting menu of the communication mode, a menu for obtaining the MAC address serving as identification information (ID) of the DVD recorder 32 is set (in step S2).

The DVD recorder 32 reproduces the setting of the communication mode from the menu screen (in step S3). In the communication mode, the acquisition of the MAC address serving as the identification information (ID) of the digital camera 31 is requested (in step S4).

The digital camera 31 requests the transmission of the ID of the digital camera 31 and the transmission of the ID of the DVD recorder 32 to the DVD recorder 32 (in step S5). The DVD recorder 32 recognizes the ID of the digital camera 31 in response to the request for sending the ID in step S5, returns the ID of the DVD recorder 32 to the digital camera 31, and exchanges the IDs (in step S6).

The IDs of the digital camera 31 and the DVD recorder 32 are checked by exchanging the IDs in steps S5 and S6, and the mutual communication is recognized (in step S7). After checking the mutual communication in step S7, the digital camera 31 checks and requests the recording capacity of the compressed image on the DVD recorder 32 side (in step S8). In response to the request in step S8, the DVD recorder 32 returns information on the recording capacity such as a maker name, type No., and free capacity of the recording medium of the DVD recorder 32 (in step S9).

The digital camera 31 determines based on the information on the recording capacity from the DVD recorder 32 in step S9 that the compressed image data is transferred (in step S10). Then, a file of the compressed image data to be transferred is selected from the menu screen on the digital camera 31 (in step S11). The compressed image data of the selected file is transferred to the DVD recorder 32 (in step S12).

The compressed image data of the file transferred from the digital camera 31 is received by the DVD recorder 32, and is recorded to the recording medium as stream of the compressed image data (in step S13). The DVD recorder 32 returns, to the digital camera 31, the recording state of the compressed image data of the file transferred from the digital camera 31 to the DVD recorder 32 (in step S14). In the DVD recorder 32, it is checked that the transferred file is normally recorded (in step S15). Then, it is checked whether or not the compressed image data of another file recorded to the digital camera 31 is transferred. When it is checked that the compressed image data of the other file is transferred, the processing returns to step S11. When it is checked that the compressed image data of the other file is not transferred, the transfer operation ends.

A personal computer for receiving the compressed image data is connected to the USB output terminal 22 of the digital camera 31. The personal computer allows the compressed moving image data transferred from the digital camera 31 to be temporarily recorded to an HDD thereof, and the moving image to be displayed on the monitor. Further, in the personal computer, the moving image is recorded in a DVD-video format or DVD-VR format by using authoring burning application or the like arranged to the personal computer.

Next, a description is given of another connecting method of the digital camera 31 and the DVD recorder 32 by the LAN cable according to the embodiment of the present invention with reference to FIG. 5.

FIG. 5 is an explanatory diagram for explaining the state of connecting the DVD recorder and the TV monitor to the digital camera device via a cradle by the LAN line according to the embodiment of the present invention.

Referring back to FIG. 2, in the connection of the digital camera 31 and the DVD recorder 32, the LAN cable 35 is directly connected to the LAN output terminal 21 of the digital camera 31. However, generally, the digital camera 31 does not have the LAN output terminal 21 and has only the USB output terminal 22 in many cases.

A cradle 40 has a converting function for transferring the data from the USB output terminal 22 by the LAN line. Thus, the USB output terminal 22 of the digital camera 31 may be connected to the cradle 40 by using the function arranged to the cradle 40, and further may be connected to the DVD recorder 32 from the cradle 40 via the LAN cable 35, the router 33, and the LAN cable 36.

That is, the digital camera 31 according to the present invention converts the picked-up compressed image data into the compressed image data in conformity with the DVD-VR format serving as the recording format of the DVD recorder 32, and records the converted data to the recording medium. The compressed image data in the DVD-VR format is fast recorded to a DVD-RAM at several millions times without deterioration of image quality, and is further transferred and is recorded to another DVD-RAM for a time shorter than the actual time for recording the picked-up image of the subject. In the digital camera 31, the sequence header has the address information of the first P picture and the second P picture of the picture frame starting the I picture from among the plurality of picture frames comprising the I picture, P picture, and B picture forming a group of pictures GOP upon recording the digital video data in the DVD-VR format. Thus, in the DVD recorder, the address information of the first P picture and the second P picture is recognized upon converting the data in the DVD-VR format into the data in the DVD-Video format. As a consequence, the data is fast transferred and recorded without re-encoding the data in the DVD-VR format into the data in the DVD-Video format. The fast transfer and recording is the same in the personal computer. The authoring software of the personal computer facilitates the conversion of the data to the DVD-Video format.

It is possible to fast transfer and record, to the DVD recorder 32 or personal computer, the compressed moving image data that is picked-up, is generated, and is recorded by the digital camera 31, by using the LAN line or USB line.

The compressed image data of the moving image is described according to the embodiment of the present invention. Needless to say, the present invention can be applied to the still image including audio information.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

1. A digital camera device comprising:
an image pick-up unit which picks up an image of a subject and generates a video signal;
a digital compressed image data generating unit which generates digital compressed image data having a large number of picture groups comprising a plurality of picture frames based on the video signal from the image pick-up unit, and which adds, to a header portion of the picture group, address information on a predetermined picture frame in the picture groups of the digital compressed image data; and
a recording unit which records, to a recording medium, the digital compressed image data that is generated by the digital compressed image data generating unit.

2. The digital camera device according to claim 1, wherein the digital compressed image data recorded to the recording medium is fast transferred to image recording and reproducing devices via data transfer lines, in the same state of the digital compressed image data.

3. The digital camera device according to claim 1, wherein the digital compressed image data recorded to the recording medium is fast transferred to image recording and reproducing devices by a cradle connected via data transfer lines in the same state of the digital compressed image data.

4. The digital camera device according to claim 1, wherein, in the digital compressed image data, the header portions of the picture groups have address information of a first P picture and a second P picture in each of the picture groups comprising a plurality of picture frames starting an I picture.

5. The digital camera device according to claim 2, wherein, in the digital compressed image data, the header portions of the picture groups have address information of a first P picture and a second P picture in each of the picture groups comprising a plurality of picture frames starting an I picture.

6. The digital camera device according to claim 3, wherein, in the digital compressed image data, the header portions of the picture groups have address information of a first P picture and a second P picture in each of the picture groups comprising a plurality of picture frames starting an I picture.

7. A method for generating an image pick-up signal, comprising:
a step to generate digital compressed image data having a large number of picture groups comprising a plurality of picture frames based on a video signal generated by picking-up an image of a subject; and
a step to generate the digital compressed image data comprising a header portion of each of the picture groups comprising address information on a predetermined picture frame in the picture groups of the digital compressed image data and record the generated data to a recording medium.

8. The method for generating an image pick-up signal according to claim 7, wherein the digital compressed image data recorded to the recording medium is fast transferred to image recording and reproducing devices via data transfer lines, in the same state of the digital compressed image data.

9. The method for generating an image pick-up signal according to claim 7, wherein the digital compressed image data recorded to the recording medium is fast transferred to image recording and reproducing devices by a cradle connected via data transfer lines in the same state of the digital compressed image data.

10. The method for generating an image pick-up signal according to claim 7, wherein the digital compressed image data has, in a header portion of the picture group, address information of a first P picture and a second P picture in each of the picture groups comprising a plurality of picture frames starting from an I picture.

11. The method for generating an image pick-up signal according to claim 8, wherein the digital compressed image data has, in a header portion of the picture group, address information of a first P picture and a second P picture in each of the picture groups comprising a plurality of picture frames starting an I picture.

12. A method for generating an image pick-up signal according to claim 9, wherein the digital compressed image data has, in a header portion of the picture group, address information of a first P picture and a second P picture in each of the picture groups comprising a plurality of picture frames starting an I picture.
